(19) United States
(12) Patent Application Publication
(10) Pub. No.: US 2013/0133827 A1
(43) Pub. Date: May 30, 2013

(54) METHOD FOR MANUFACTURING JOINTS OF METALLIC SHEETS AND POLYMER COMPOSITES USING ADHESIVE

(71) Applicant: Jeong Min Cho, Uiwang (KR)

(72) Inventor: Jeong Min Cho, Uiwang (KR)

(73) Assignee: HYUNDAI MOTOR COMPANY, Seoul (KR)

(21) Appl. No.: 13/367,527

(22) Filed: Feb. 7, 2012

(30) Foreign Application Priority Data
Nov. 28, 2011 (KR) 10-2011-0125319

(51) Int. Cl. B32B 38/10

(52) U.S. Cl. 156/281

(57) ABSTRACT

Disclosed is a method for manufacturing a joint of a metallic sheet and a polymer composite. In the method, a metallic sheet and a polymer composite are prepared. Oil components are removed from bonding surfaces of the metallic sheet and the composite using a solvent. An adhesive is applied to the bonding surfaces. The metallic sheet and the polymer composite are bonded to form the joint. The joint is heated while fixing the joint to primarily cure the adhesive by about 60% to about 80% at a predetermined temperature. The joint is heated to secondarily cure the adhesive fully at a higher second temperature than the predetermined first temperature.

### CROSS-REFERENCE TO RELATED APPLICATION

This application claims under 35 U.S.C. §119(a) the benefit of Korean Patent Application No. 10-2011-0125319 filed Nov. 28, 2011, the entire contents of which are incorporated herein by reference.

### BACKGROUND

(a) Technical Field

The present invention relates to a method for manufacturing joints of metallic sheets and polymer composites using an adhesive. More particularly, it relates to a method for manufacturing joints of metallic sheets and polymer composites using an adhesive, which can facilitate bonding between heterogeneous metallic sheets and polymer composites according to the characteristics thereof by performing a curing process of the adhesive in two stages, and increases the bonding strength of the joints by reducing the thermal residual stress due to bonding.

(b) Background Art

Generally, joints are frequently configured with a structure in which metallic materials and polymer composites having heterogeneous characteristics are bonded and cured to form a structure. Particularly, high-temperature curing adhesives are often used to obtain a desired structural performance in manufacturing joints of carbon fiber/polymer composites and metallic materials. However, since the carbon fiber/polymer composites and metallic materials have different thermal expansion coefficients, thermal residual stress may occur in the joints when they are cooled from a curing temperature to a service temperature during adhesion and curing processes using a high-temperature curing adhesive.

For example, when joints are manufactured by bonding aluminum materials and carbon fiber-polymer composites using an adhesive, a thermal residual stress may occur while curing the adhesive as shown in FIG. 1. The thermal residual stress may increase the shearing stress of the adhesive layer to reduce the strength of the joints. Particularly, in two-sided joints, the strength is significantly reduced by the thermal residual stress.

A technology related similar materials associated with joints of metallic materials and polymer composites is disclosed in Japanese Patent Publication No. 2004-330565, which proposes a composite sheet that is manufactured by heating a metallic plate coated with resin composition at a temperature of 60° C. to 100° C. to remove a solvent and then stacking metallic plates on both surfaces thereof at a temperature of 130° C. for 1.5 minutes. Also, U.S. Patent Application Publication No. 2011-0059290 discloses bonded assemblies and methods for improving the bond strength of a joint by performing a curing process to bond surfaces of a first component and a second component.

However, in the above technologies, since the joints are not joints of metallic materials and polymer composites, and the process of curing the adhesive is complicated, the above technologies cannot overcome strength reduction of the joints due to thermal residual stress after heterogeneous materials are bonded into joints and cured.

Furthermore, Korean Patent No. 325,406 discloses a method for manufacturing a CARALL hybrid composite material for an aircraft, which includes removing foreign substance from a bonding surface of an aluminum plate, curing carbon/epoxy prepregs, and stacking the solidified carbon/epoxy laminate and the aluminum plate to bond each other. However, although the process for curing a carbon fiber-reinforced resin material is performed in two stages, the first curing is to change semisolid carbon/epoxy prepreg into solid laminate, and the second curing is to stack and bond the aluminum plate, an adhesive film, and the laminate together. In this case, the two-stage curing process is not performed on the adhesive applied to the joints, but rather the first curing is to cure the semisolid carbon/epoxy prepreg and the second curing is to cure the adhesive film. In other words, the curing process is performed by high-temperature and high-pressure single curing method (e.g., secondary curing process for 90±10 minutes at a temperature of 177±6° C. and a pressure of 50 to 80 psi). Accordingly, there are still thermal residual stresses in the hybrid composite, induced from the manufacturing process, that may limit its structural performance in terms of strength.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method for manufacturing joints of metallic sheets and polymer composites using an adhesive, which can control the curing conditions of the adhesive under a natural condition to reduce a thermal residual stress caused by the heterogeneous characteristics of the bonding materials when the metallic sheets and the polymer composites are bonded using the adhesive.

The present invention provides a method for manufacturing joints of metallic sheets and polymer composites using an adhesive, which can facilitate bonding between heterogeneous metallic materials and polymer composites and can increase the bonding strength.

In one aspect, the present invention provides a method for manufacturing a joint of a metallic sheet and a polymer composite, including: preparing the metallic sheet and the polymer composite; removing oil components from bonding surfaces of the metallic sheet and the composite using a solvent; applying an adhesive on the bonding surfaces and bonding the metallic sheet and the polymer composite to form the joint and then fixing the joint; heating the joint while fixing the joint to primarily cure the adhesive by about 60% to about 80% at a predetermined temperature; and heating the joint to secondarily cure the adhesive fully at a higher temperature than the predetermined temperature.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a thermal residual stress of joints manufactured by bonding metallic sheets and polymer composites using a typical method;

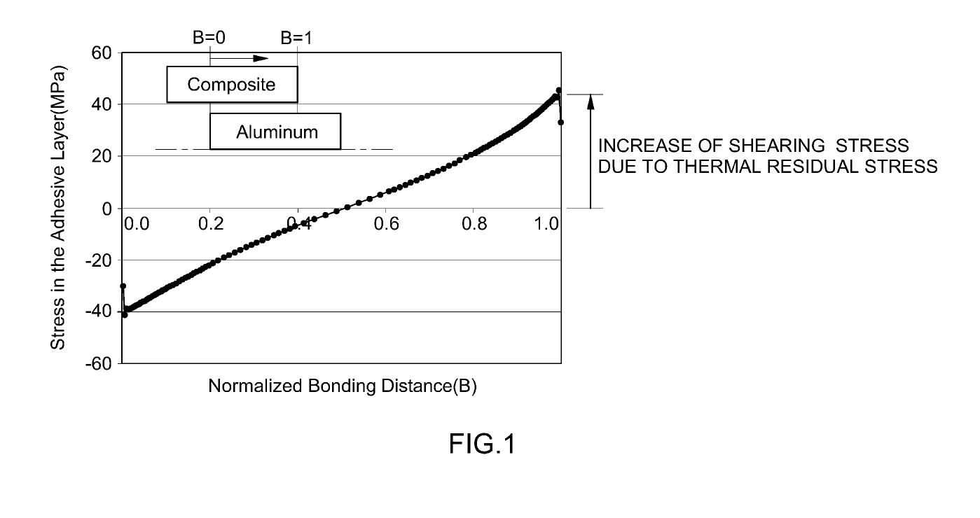

FIG. 2 is a view illustrating a comparison of curing degrees according to temperature and time in a typical curing process and a two-stage curing process according to an exemplary embodiment of the present invention;

FIG. 3 is a graph illustrating progresses of curing degrees according to different curing temperatures and times with respect to an adhesive having a curing temperature of about 121° C. according to an exemplary embodiment of the present invention;

FIG. 4 is a view illustrating a functional expression of the two-stage curing process according to an exemplary embodiment of the present invention; and

FIG. 5 is a graph illustrating a comparison of the thermal residual stresses in the joints of metallic sheets and polymer composites manufactured by a comparative example and an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in detail with reference to the accompanying drawings.

The present invention relates to a method for manufacturing joints of metallic sheets and polymer composites by primarily curing an adhesive applied to the metallic sheets and the polymer composites by about 60% to about 80% at a first predetermined temperature and secondarily curing the adhesive to the full at a higher second temperature.

Examples of the metallic sheets may include aluminum, iron, an alloy, or the like thereof. Preferably an alloy of aluminum may be used. Also, the polymer composites may include carbon fiber , glass fiber or the like as reinforcing materials. Preferrably, carbon fiber/epoxy composites may be used, and thermosetting or thermoplastic resin may be used as the polymer. The polymer composite used in the present invention are typically not prepreg but rather fully-cured composites. Adhesives for bonding the metallic materials and polymer composites may include any epoxy-based adhesive. Preferably, metallic sheets and polymer composites are selected for preparation according to their purpose and shape.

Methyl ethyl ketone and acetone may be used as a solvent for removing oil components from each bonding surface of metallic sheets and polymer composites. Thus, the bonding strength between metallic sheets and polymer composites may increase. In this case, a bonding-improving agent such as silane primer may be used on the surface of metallic sheets to increase the bonding strength with an adhesive.

More specifically, in the illustrative embodiment of the present invention, an adhesive is applied on the bonding surface and the metallic sheet and the polymer composite are bonded to form and fix the joint. In this process, a clamp, for example a C-clamp, may be used as a fixing member for fixing the joint. The purpose of the fixing member is to fix each portion of the joint before the curing is completely finished.

In a process of heating the joint while fixing the joint to primarily cure the adhesive by about 60% to about 80% at a first predetermined temperature, the primary curing may be performed for about one hour to about five hours at a temperature of about 70° C. to about 90° C., respectively. If the adhesive is cured too little during the first stage, the thermal residual stress may become larger than expected due to the second stage high-temperature curing effect. On the other hand, if the amount of curing is too much during the first stage, the duration for the primary curing may excessively increase due to the amount of time it takes to reach that percent cured.

In a process of heating the joint to secondarily cure the adhesive fully at a higher second temperature than the predetermined first temperature, the secondary curing may be performed for about one hour to about two hours at a temperature of about 95° C. to about 120° C., respectively.

According to an embodiment of the present invention, the method for manufacturing joints may be performed by the two-stage curing process to cure adhesive components. In the primary curing process, the temperature at which the residual stress begins to occur may be lowered by increasing the curing degree of the adhesive at a first low curing temperature. Also, in the secondary curing process, a 100% cure for the adhesive may be achieved within reasonably short time. Here, a sufficient curing degree must be obtained during the primary curing process so as the development of thermal residual stresses are not affected by the increased curing temperature of the secondary curing process. According to an embodiment of the present invention, the curing degree of the primary curing process may range from about 60% to about 80%, preferably, from about 70% to about 80%.

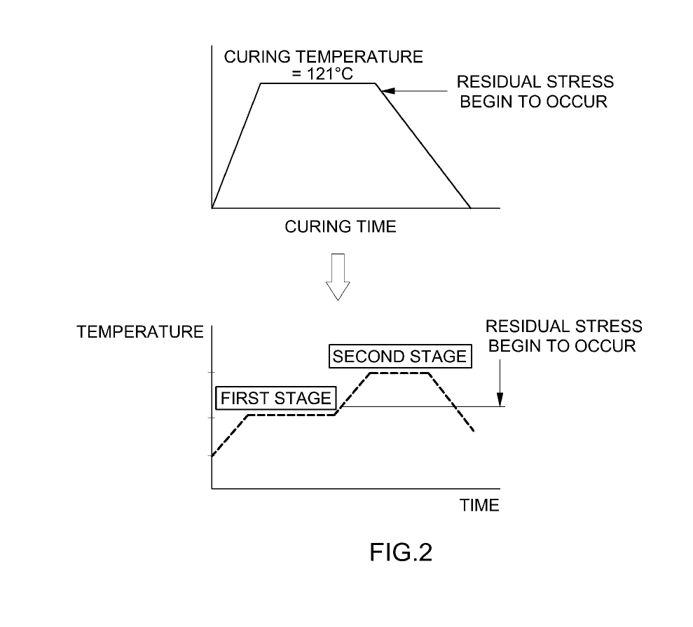

In order to conceptually understand the two-stage curing process, FIG. 2 illustrates a comparison of curing temperature and time in a typical curing process and a two-stage curing process according to an embodiment of the present invention. In FIG. 2, since the thermal residual stress is generated after the primary curing at a lower temperature than that in a typical curing process, a desired strength can be maintained.

Hereinafter, an embodiment of the present invention and a comparative example will be described in detail, but the present invention is not limited thereto.

### EMBODIMENTS

In this exemplary embodiment of the present invention, Aluminum 6061-T6 was used as metallic sheets, and continuous carbon fiber/epoxy composites were used as carbon fiber/polymer composites. Epoxy component can be cured for at least about 2 hours at a temperature of about 178° C., and has a fiber volume fraction of about 60 vol % and a density of about 1.6 g/cc.

An epoxy-based adhesive was used and manufactured by mixing Diglycidyl Ether of Bisphenol-A (DGEBA) and an amine curing agent with a weight ratio of 100:25.

(1) The metallic sheets and composites were elaborately processed for preparation.

(2) The bonding surfaces of materials used for the joint were cleaned with a solvent, methyl ethyl ketone, to remove oil components, and silane primer (purified water with about 1% silane solution) was applied to the bonding surface of the metallic sheets to facilitate bonding with the adhesive.

(3) The adhesive was applied to each bonding surface, and then a clamp was installed to fix the joints of the metallic sheets and the composites.

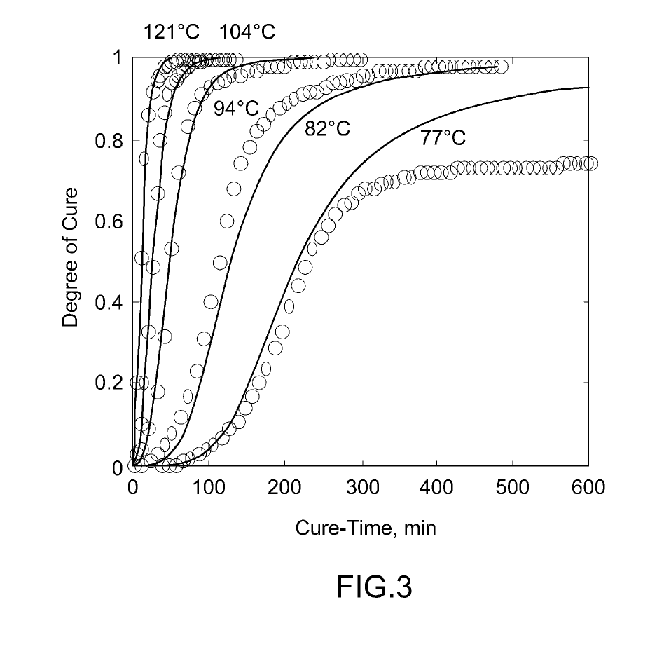

(4) The adhesive was primarily cured for about 4 hours at a temperature of about 82° C., and was secondarily cured for about 0.5 hours at a temperature of about 104° C. in an oven. As shown in FIG. 3, the primary curing and the secondary curing were performed in consideration of the progress of curing degree according to different curing temperatures and times with respect to an adhesive having a curing temperature of about 121° C.

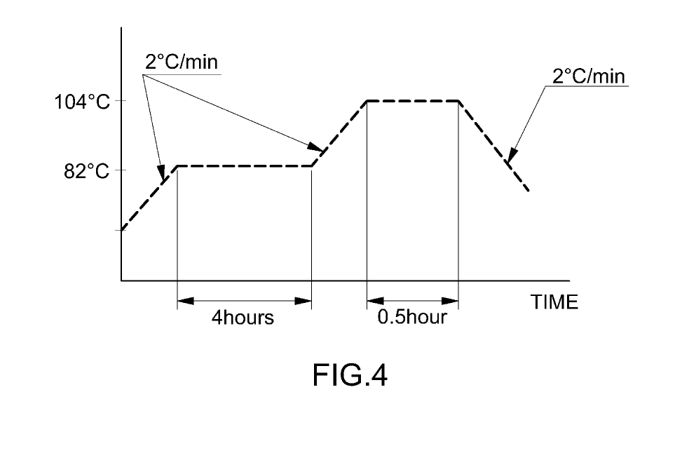

A functional expression regarding the progress of the curing temperature and time according to an embodiment of the present invention is shown in FIG. 4.

### COMPARATIVE EXAMPLE

A joint was manufactured by the same method as the above embodiment, while curing was performed for about 1 hour at a temperature of about 121° C.

### TEST EXAMPLE

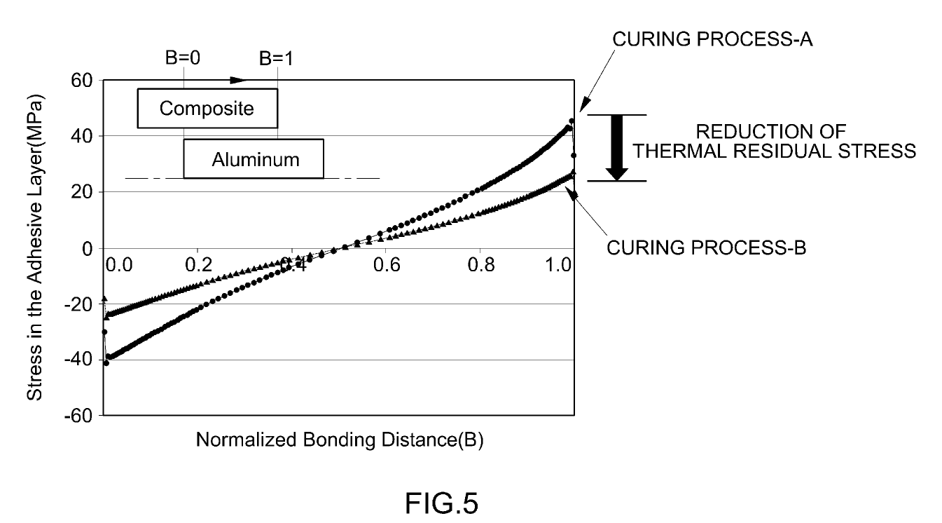

Joints of the embodiment and the comparative example were tested for thermal residual stress. The test results are shown in FIG. 5. It can be understood that the thermal residual stress was more significantly reduced in the embodiment (curing process B) than the comparative example (curing process A).

According to embodiments of the present invention, a method for manufacturing joints of metallic sheets and polymer composites using an adhesive significantly increase the static strength and the fatigue strength of the joints, by effectively reducing the thermal residual stress occurring in an adhesive layer due to a two-stage curing process.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a joint of a metallic sheet and a polymer composite, comprising:
preparing the metallic sheet and the polymer composite;
removing oil components from bonding surfaces of the metallic sheet and the composite using a solvent;
applying an adhesive on the bonding surfaces and bonding the metallic sheet and the polymer composite to form the joint and then fixing the joint;
heating the joint while fixing the joint to primarily cure the adhesive by about 60% to about 80% at a predetermined first temperature; and
heating the joint to secondarily cure the adhesive fully at a second temperature higher than the predetermined temperature.

2. The method of claim 1, wherein the metallic sheet comprises aluminum.

3. The method of claim 1, wherein the polymer composite comprises a carbon fiber and epoxy.

4. The method of claim 1, wherein the adhesive comprises an epoxy-based adhesive.

5. The method of claim 1, wherein the primary curing of the adhesive is performed for about one hour to about five hours at a temperature of about 70° C. to about 90° C.

6. The method of claim 1, wherein the secondary curing of the adhesive is performed for about one hour to about two hours at a temperature of about 95° C. to about 120° C.

7. A method for manufacturing a joint of a metallic sheet and a polymer composite, comprising:
preparing the metallic sheet and the polymer composite;
removing oil components from bonding surfaces of the metallic sheet and the composite using a solvent;
applying an adhesive on the bonding surfaces;
bonding the metallic sheet and the polymer composite to form and fix the joint;
first heating the joint while fixing the joint to primarily cure the adhesive by about 60% to about 80% at a predetermined first temperature; and
then heating the joint to secondarily cure the adhesive fully at a second temperature higher than the predetermined first temperature.

8. The method of claim 1, wherein the metallic sheet is selected from a group consisting of aluminum, iron and an alloy.

9. The method of claim 1, wherein the polymer composite comprises a glass fiber and epoxy.

10. The method of claim 1, wherein the adhesive comprises an epoxy-based adhesive.

11. The method of claim 1, wherein the primary curing of the adhesive is performed for about one hour to about five hours at a first temperature of about 70° C. to about 90° C.

12. The method of claim 1, wherein the secondary curing of the adhesive is performed for about one hour to about two hours at a second temperature of about 95° C. to about 120° C.
